(19) United States
(12) Patent Application Publication
(10) Pub. No.: US 2002/0081015 A1
(43) Pub. Date: Jun. 27, 2002

(54) 3D Material analysis

(76) Inventors: Jens Alkemper, Evanston, IL (US); Peter W. Voorhees, Winnetka, IL (US)

Correspondence Address: Mr. Edward J. Timmer, Walnut Woods Centre, 5955 W. Main Street, Kalamazoo, MI, 49009, US

(21) Appl. No.: 09/747,493

(22) Filed: Dec. 21, 2000

(51) Int. Cl. G06K 9/00

(52) U.S. Cl. 382/141; 382/154

(57) ABSTRACT

Method for generating a three dimensional image of a sample of a material on a micrometer length scale comprises disposing the sample of the material on a sample holder, moving the sample holder to a first location where a tool is moved in a first direction toward the sample to remove material from the sample to provide a sample cross-section, moving the sample holder in a second direction to a second location where a digital image of the sample section is generated and stored, sensing the position of the sample holder at the second direction and storing the sensed position associated with the digital image, repeating steps a) through d) to provide a series of digital images and a corresponding series of sensed positions, and constructing a three dimensional image of the sample using the series of digital images and the corresponding series of sensed positions.

### CONTRACTUAL ORIGIN OF THE INVENTION

This invention was supported in part by funding from the Federal Government through NASA under Grant No. NAG3-1823. The Government may have certain rights in this invention.

### FIELD OF THE INVENTION

The present invention relates to automated serial sectioning of metallic and other materials and three dimensional reconstruction of the sections to visualize the material in three dimensions.

### BACKGROUND OF THE INVENTION

A commonly used method for serial sectioning of a material, such as a metal or alloy, has involved successive grinding/polishing of a sample to provide a planar section thereof and then photographing each successive planar section. Such a method is described by Mangan et al. in article entitled “Three-dimensional reconstruction of Widmanstatten plates in Fe-12.3Mn-0.8C”, Journal of Microscopy, 188:36-41, 1997. This method suffers from disadvantages that the distance between two successive sections may not be accurately known and that alignment of successive photographic images with regard to horizontal displacement and tilt is tedious and time consuming. The time required to obtain and photograph successive sections thus is a major problem using this method. A method described by Wolfsdorf et al. in an article entitled “The morphology of high volume fraction solid-liquid mixtures: an application of microstructure tomography”, Acta Materialia, 45(6) :2279-2295, 1997, employs a micromiller to machine successive sample sections, which are subsequently etched and photographed using a microscope after the sample is removed from the micromiller. The photographic images of the samples are aligned using the microstructural features of the individual milled and etched sections. This tedious alignment procedure as well as uncertainties in sample positioning introduced by the repeated mounting and unmounting of the samples from the micromilling machine are major disadvantages of the technique. An object of the present invention is to provide a method and apparatus for serial sectioning of a material in a manner that overcomes the disadvantages of the previous serial sectioning and photographing techniques.

### SUMMARY OF THE INVENTION

In one embodiment, the present invention provides a method and apparatus for generating a three dimensional image of a sample of a material involving the steps of disposing the sample of the material on a sample holding device, relatively moving the sample holding device and a tool at a first material removal location where the tool removes a predetermined thickness of material from the sample to provide a sample cross-section, moving the sample holding device to a second location where a digital image of the sample cross-section is generated and stored, sensing the position of the sample holding device at the second location where the digital image is generated and storing the sensed position, and repeating the above steps to provide a series of digital images and a corresponding series of sensed positions. In a computer, respective sub-images from each respective digital image are generated and aligned with respect to one another in response to the respective sensed position of the sample holding device. The sub-images are stacked to reconstruct the three dimensional image of the sample. The invention is advantageous in serially sectioning and examining opaque materials, such as metal and alloy microstructures, biological structures such as for example bones and teeth, and other materials which are not transparent to light.

The invention is further advantageous in that structures can be examined pursuant to the invention on a micrometer length scale and reconstructed in three dimensions with a separation distance between successive sample cross-sections as small as 2 microns.

The objects and advantages of the present invention will become more readily apparent from the following description taken with the following drawings.

### DESCRIPTION OF THE DRAWINGS

FIG. 1 is a schematic view of apparatus in accordance with an embodiment of the invention for serially sectioning and photographing successive sample sections.

FIG. 1A is a schematic diagram of wiring between a micromiller control box and a switchboard. FIG. 1B is a schematic diagram of micromiller control box internal potentiometer (“pot”) and one of the external potentiometers.

FIG. 2 is similar to FIG. 1 after the sample holding device has been stopped at a “cutting start” location with the tool ready to cut the sample to form the sample cross-section. The base plate 11 has been omitted from FIGS. 2-5 for convenience.

FIG. 3 is similar to FIG. 2 after the sample holding device has been moved to an “end cutting” location after the tool has cut a cross-section on the sample.

FIG. 4 is similar to FIG. 3 after the sample holding device has been moved to within a selected distance close to a “photo” location where, at the selected distance, the speed of the sample holding device is reduced.

FIG. 5 is similar to FIG. 4 after the sample holding device is positioned at the “photo” location with the sample cross-section beneath the microscope.

FIG. 6a, 6b, 6c and 6d are schematic illustrations showing the sequence of computer alignment of a series of vertically stacked sample section images of a sample with a spherical body therein.

FIG. 6a illustrates a series of vertically stacked images. FIG. 6b illustrates using the sensed sample holder positions and the subsequent cutting or erasing of lines of the images to create sub-images, FIG. 6c illustrates a stack of sub-images aligned from which a three dimensional (3D) representation, FIG. 6d, can be obtained. In FIG. 6d, not all of the sub-images are shown that are used to reconstruct and visualize the sample; the missing sub-images being present in the locations represented by black dots (three shown only for convenience) to permit reconstruction and visualization of the sample.

FIG. 7 is a perspective view of milling apparatus for practicing the invention.

FIG. 8 is a perspective view of milling apparatus showing the carrier member, base plate, sample holding device, and positioning sensing device for the sample holder.

### DETAILED DESCRIPTION OF THE INVENTION

The present invention provides method and apparatus for sectioning and examining a sample of a material which may comprise a metal, metal alloy, biological material, and other organic or inorganic material that is opaque or only partially transmissive to light. Exemplary metals and alloys that can be sectioned and examined pursuant to the invention include, but are not limited to, standard aluminum metal and aluminum alloys. Exemplary biological materials that can be sectioned and examined pursuant to the invention include, but are not limited to, bones and teeth.

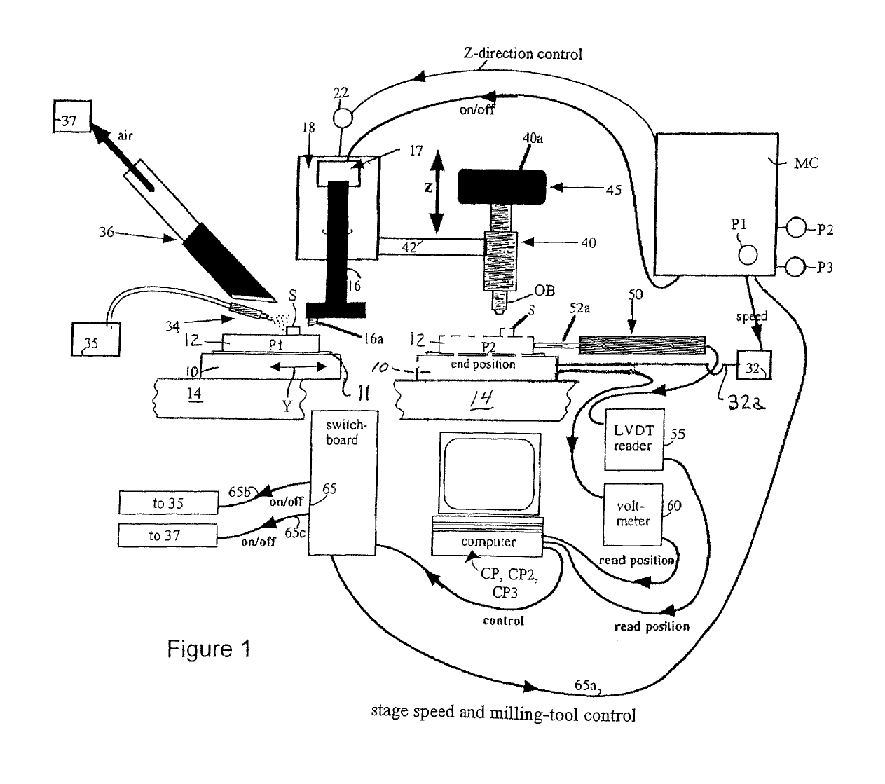

Referring to FIG. 1, apparatus pursuant to an embodiment of the invention can be based on a conventional machine tool used heretofore for sectioning material for metallographic or other examination. For example, a micromilling machine available as a Polycut E micromiller from Leica Microsystems, Nussloch GmbH, Heidelberger Str. 17-19, 69226 Nussloch, Germany, can be modified pursuant to the invention to enable serial sectioning and examination of a material sample in accordance with a method embodiment of the invention.

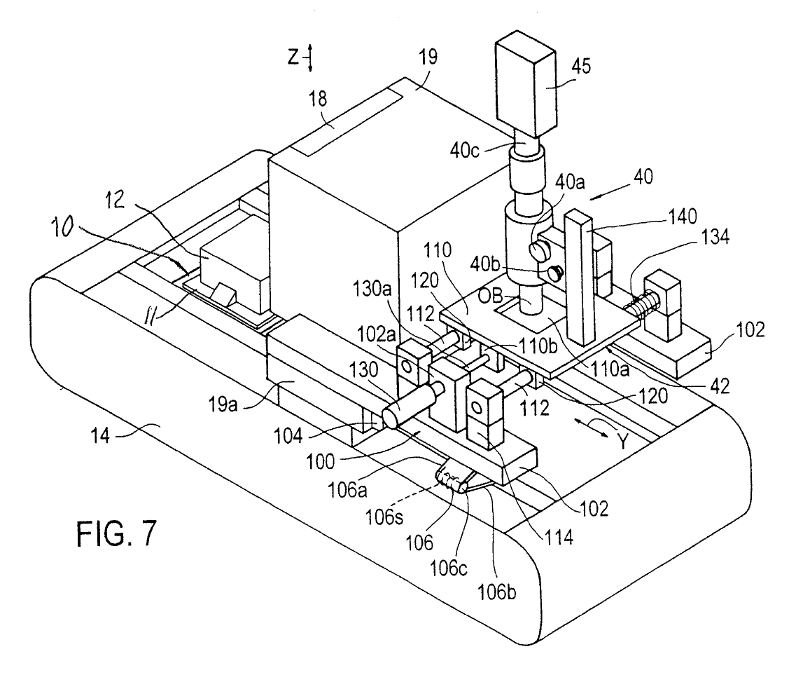

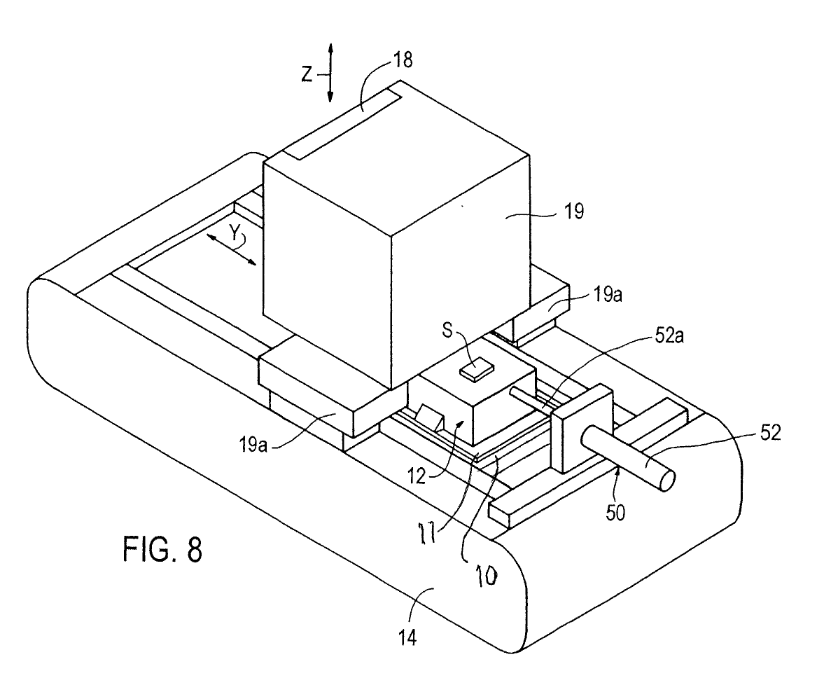

Referring to FIGS. 7 and 8, such Polycut E micromilling machine comprises a screw-driven slide or carrier member 10 on which a base plate 11 and a sample holding device 12 are disposed for movement with the carrier member 10. The carrier member 10 is movable back and forth in direction Y as indicated in FIGS. 1, 7 and 8 on the base 14 of the micromilling machine. A belt-like dust cover (not shown) is provided over the carrier member 10.

Such Polycut E micromilling machine includes a rotatable milling tool 16 disposed on a tool head slide 18, FIG. 1. The milling tool 16 is rotated by an actuator motor 17 on the tool head slide 18 as shown schematically in FIG. 1. The tool head slide 18 is slidable on a fixed housing 19, FIG. 7, for movement in a Z (vertical) direction relative to the stage belt member 10 toward the material sample S on the sample holder 12. A tool head slide actuator motor 22 (an electric stepper motor) is connected to the tool head slide 18 for moving the tool head slide in the Z direction in predetermined increments as also shown schematically in FIG. 1. The milling tool 16 includes a diamond cutter 16a to section the material sample S in controlled increments in the Z direction. The sample S on the sample holding device 12, which may comprise a clamp type or vacuum suction type sample holder connected by base plate 11 to carrier member 10 and provided with the micromilling machine, is moved by carrier member 10 in the Y direction under rotating cutter 16a to remove a predetermined incremental thickness from the top of the sample S.

The sample S on sample holding device 12 is moved by carrier member 10 in the Y direction perpendicular to the Z direction between a first material removal location or position Pi comprising “start” and “end” cutting positions described below where the sample holding device 12 is positioned beneath the milling tool 16 to machine the serially cross-section in the material sample S and a second location or position P2. In such Polycut E micromilling machine, the carrier member 10 is driven to move in the Y direction by a precision screw 32a (shown schematically in FIG. 1) and screw actuator motor 32 (e.g. a DC rotary motor) that moves the carrier member 10 and thus the sample holding device 12 thereon between the first location P1 and the second location P2. At location P1, an alcohol spray nozzle 34 and a vacuum tube 36 are disposed. The alcohol spray nozzle 34 is communicated to alcohol pump 35 actuated to spray alcohol on the sample S during the milling process. The vacuum tube 36 is communicated to a source of vacuum 37, such as a conventional vacuum cleaner, to remove debris from the sample S as it is being sectioned by the milling tool 16. In accordance with the invention, at location P2, an optical microscope 40 having a conventional objective OB and projection lens (not shown) is disposed on a microscope stage 42, and the microscope stage 42 is mounted on the tool head slide 18 on a platform 100, FIG. 7. The platform 100 includes a pair of cantilevered support bars 102 affixed by fasteners on the base mounts 19a of the fixed housing 19 located on opposite sides thereof on the machine base 14. An underlying cross support bar 104 is affixed to the cantilevered support bars 104 and extends between them. The cantilevered end of each support bar 102 is supported and cushioned by a V-shaped, spring biased hinge support 106. Each support 106 includes an upper member 106a connected to a respective support bar 102 and lower member 106b connected to base 14 with the intermediate ends of members 106a, 106b joined together by screw 106c that is received in a biasing coil spring 106s to form a spring biased hinge support.

A microscope holder plate 110 is disposed on a pair of rails 112 that are disposed on support blocks 114, which in turn are affixed on the support bars 102. Each rail 112 includes a pair of pillow blocks 120 to provide four pillow blocks 120 on which the microscope holder plate 110 is affixed. The pillow blocks 120 comprise ball bush bearings that allow the pillow blocks 120, and thus the microscope holder plate 110 thereon, to move along the length of the rails 112 in a direction perpendicular to the Y direction. The rails 112 with pillow blocks 120 are available commercially form Thomson Industries, Inc. of 2 Channel Dr., Port Washington, N.Y. 11050, U.S.A. The microscope holder plate 110 includes an opening 110a in which the microscope objective OB is received.

A conventional micrometer 130 is mounted on an upstanding flange 102a on support bar 102 and includes a movable end 130a that engages a depending flange 110b of the microscope holder plate 110 to move it along the rails 112. A coil spring 134 (one shown) is provided on each rail 112 on the opposite side of the microscope holder plate 110 to bias the plate 110 back toward the micrometer end 130a. The micrometer 130 is used to move the microscope across the sample in the X direction at the beginning of the process. This is useful when picking an interesting area to reconstruct. Movement in the Y direction is given through the carrier member 10 itself.

The microscope 40 is mounted on an upstanding support post 140 on the microscope holder plate 110 with the objective lens OB received in the plate opening 110a.

By use of the above described mounting means, the microscope 40 moves in the Z direction synchronously with the tool head slide 18 and the milling tool 16 thereon in practice of the invention.

The microscope 40 includes a conventional 10X objective lens OB, projection lens and fine and coarse knob adjustments 40a, 40b with such microscope components being available from Melles Griot Inc., 55 Science Parkway, Rochester, N.Y. 14620, U.S.A.

By mounting the microscope 40 to travel synchronously with the tool head slide 18, there is no need to refocus the microscope during serial sectioning and examination of the sample S wherein the tool head slide 18 is moved in successive preselected increments in the Z direction in order to serially section the material sample S. The microscope 40 is mounted to align its optical axis parallel to a normal to the sectioned surface of the sample S.

A digital camera 45 is connected to the microscope body by adapter 40c disposed between the microscope and camera to take pictures of each serial section of the sample S at position P2. The digital camera 45 can comprise a model Kodak OCS330 digital camera. The digital camera 45 is interfaced via a firewire connection to a firewire port of a computer CP which may comprise an Apple model PowerMac computer, FIG. 1. Different digital camera may be connected to the computer using different ports thereof. The digital camera 45 thereby inputs to the computer digital signals representative of each serial sample section photographed at location P2. The memory of computer CP is used to receive and store the digital images and a second computer CP2 is used for reading and storing sample position data, sample movement control, and user interface. The second computer CP2 can comprise a Gateway PC running WIN98 software. Computers CP, CP2, CP3 are shown as one computer processing unit in FIG. 1 for purposes of convenience. Other computer processing systems or other arrangements of one or more computer processing devices can be employed in practicing the invention.

Referring to FIG. 8, a position sensing device 50 is provided pursuant to the invention for sensing the position of the sample holding device 12 in the Y direction at the second location P2. In particular, the position sensing device can comprise a linear variable differential transformer (LVDT) 52 disposed on the machine bed 14 to sense the position of the sample holding device 12 in the Y direction. An LVDT 52 available as model GCA-121-500 from Lucas Control Systems Products, Hampton, Virginia, can be used in practice of the invention to sense the position of the sample holding device 12 with an accuracy better than 0.5 microns in the Y direction. The LVDT 52 can include a plunger 52a that is engaged by the sample holding device 12 to sense position of the sample holding device 12 in the Y direction. In lieu of a plunger, the position sensing device 50 may comprise a transducer that senses a magnetic field of a permanent magnet on the sample holding device 12 by sensing a magnetic field. Any other position sensing device can be used in practice of the invention as well so long as satisfactory position resolution data in the Y direction is provided by the device. The positioning sensing device 50 is interfaced to an LVDT reader device 55 that is interfaced to a port (e.g. a serial port) of computer CP, FIG. 1. The LVDT reader device 55 thereby can input to computer CP digital signals representative of successive serial sensed positions of the sample holding device 12 in the Y direction at position P2. For each sample section photograph taken by camera 45, the sensed sample holding device position in the Y direction where the picture was taken is input to the computer CP. The computer CP stores the digital signals representative of the sample section photograph taken at a sensed sample holding device position. Computer CP2 reads and stores each sensed position of the sample holding device 12 in the Y direction at the second position P2 where the associated digital signals representative of the sample section photograph are taken at that sensed sample holding device position. A series of sensed positions of the sample holding device 12 and associated digital images or data are stored for use in reconstructing a three dimensional (3D) image of the material sample S using a third faster computer CP3 in a manner described below. The third computer CP3 can comprise a Visualize J5000 computer available from Hewlett Packard (HP).

Referring to FIG. 1, a voltmeter 60 is operatively associated with the carrier member 10 pursuant to the invention and provides a voltage signal proportional to the position of the carrier member 10 on the machine bed 14. The voltmeter can comprise a model Fluke 45 voltmeter available from Fluke Corporation, 6920 Seaway Blvd., Everett, Wash. 98206, U.S.A., to determine position of the stage belt member 10 within 1 centimeter in the Y direction. In particular, the as-purchased Polycut E micromilling machine is constructed such that movement of the carrier member 10 drives a variable resistance potentiometer (not shown but provided with the micromilling machine) which splits an external 14 V into two voltages V1 and V2 such that V1 +V2 =14V. By reading either one of the voltages V1 or V2, one can estimate the position of the carrier member 10. The voltmeter 60 is connected to the aforementioned variable resistance potentiometer and computer CP2.

The speed of the carrier member 10 relative to tool 16 is controlled by computer CPl to control cutting speed of the sample S by switching between a potentiometer P1 (micromiller control speed) provided on the as-purchased micromilling machine or an external potentiometers P2 (speed 2 such as slow speed), P3 (speed 1 such as fast speed) or a fixed resistor R (stop) connected as shown in FIG. 1A to relays R1 to R8 of the switchboard 65. In FIGS. 1A and 1B, the terminal designations A, B, C, D, E, F, H, J and K are color coded wires between the micromiller control box and on switchboard 65.

To switch the milling tool on/off button, the relay R7 and R8 are switched together. To switch to micromiller control box speed, relay R1 is switched to NC where NC means C (center) and NC (normal connected) are connected. To switch to speed 2, relay R1 is switched to NO where NO means C (center) and NO (normal open) are connected, relay R2 is switched to NO, relay R3 is switched to NC, and relay R4 is switched to NC. Only one NC or NO is possible at a time. To switch to speed 1, relay R1 is switched to NO, relay R2 is switched to NO, relay R3 is switched to NO, relay R4 is switched to NO, relay R5 is switched to NC, and relay R6 is switched to NC. To switch to resistor R (stop), relay R1 is switched to NO, relay R2 is switched to NO, relay R3 is switched to NO, relay R4 is switched to NO, relay R5 is switched to NO, and relay R6 is switched to NO. FIG. 1B illustrates the principle of switching from the potentiometer P1 of the micromiller control box to one of the external potentiometers P2 or P3.

The machine controller MC is connected to tool motor 17 to turn the motor 17 on/off and to motor 32 to control its speed. The computer CP1 is interfaced to the machine controller MC through switchboard 65 which comprises a CIO-ERB4 relay system (embodying relays R1-R8 described above) available from Measurement Computing, 16 Commerce Blvd., Middleboro, Mass. 02346. The machine controller MC receives commands via line 65a from computer CP2 through the switchboard 65 1) to control speed of the motor 32 to control speed of carrier member 10 in the Y direction and 2) to control motor 17 (on or off).

Movement of the carrier member 10 in the Y direction is among the following: 1) “stop” for stopping the sample holder at locations P1 and P2, 2) a “cutting speed” for moving the sample holding device in the Y direction relative to milling tool 16 at location P1, 3) a “slow speed” for sample holding device movement as it approaches the location P2, and 4) a relatively “fast speed” for sample holding device movement as it moves between locations P1 and P2 as described below.

In addition, the computer processing unit CP2 Is connected via switches and lines 65b, 65c of switchboard 65 to the alcohol spray pump 35 and vacuum pump 37 connected to vacuum tube 36 so that the computer CP can control the pumps 35, 37 between “on” and “off” in practice of a method embodiment of the invention.

The computer processing unit CP2 is programmed to run the following procedure for practicing a method embodiment of the invention:

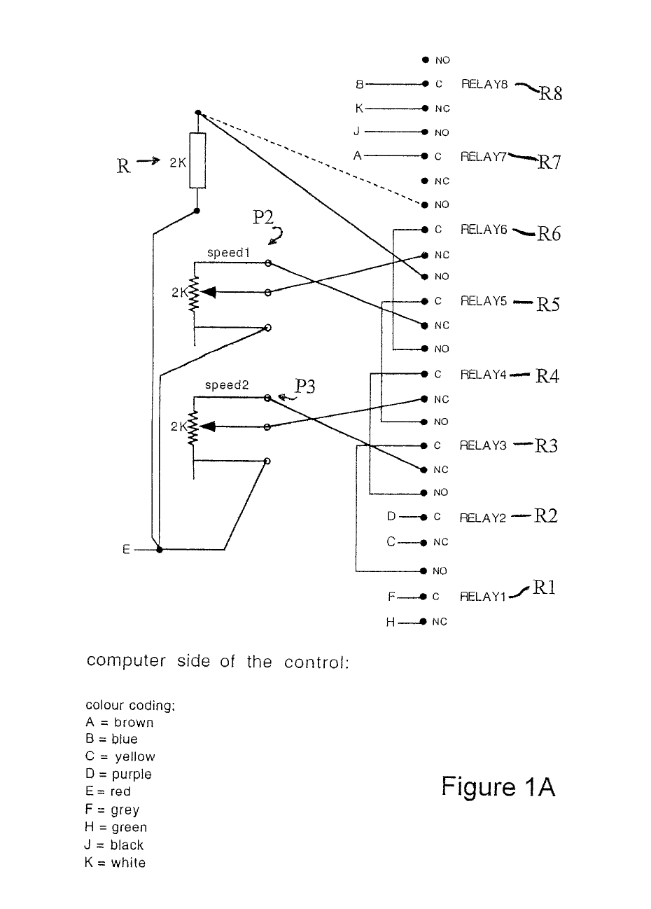

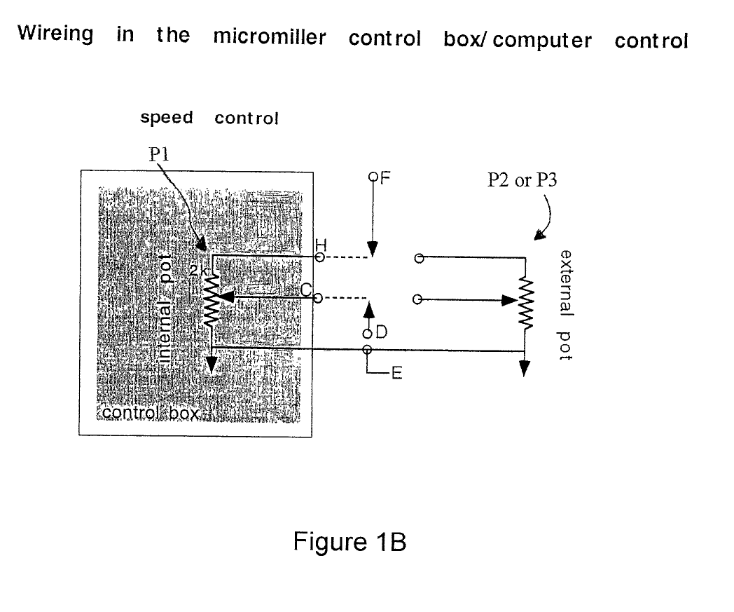

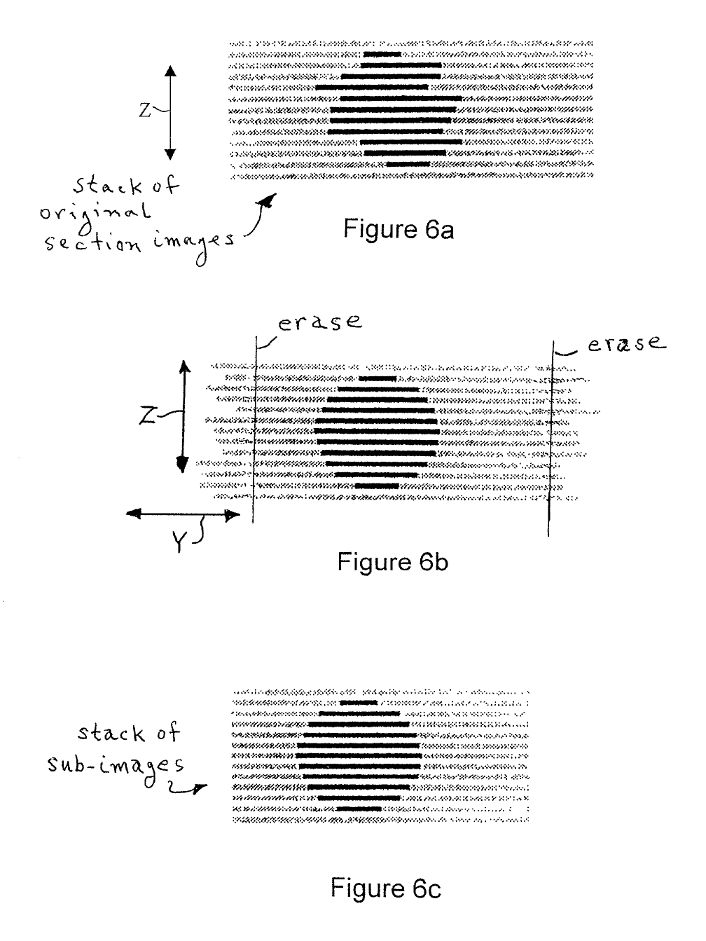

1) The user of the micromilling machine is required to bring the sample holding device 12 to different positions and then click the computer CP2 when the sample holding device is in each required positions. These positions include a “cutting start” position (FIG. 2) where the sample holding device 12 is in front of the milling tool 16; a “cutting end” position (FIG. 3) where the sample holding device has just passed the cutting area beneath the tool 16; and a “photo” position (FIG. 5) where the sample holding device is positioned beneath the microscope 40 exactly where the pictures should be taken.

The computer processing unit CP2 will for each above position determine the corresponding voltmeter read-out value and for the “photo” position the LVDT read-out value and store these read-out values in respective CPU memory of CP2.

To serially section and examine the material sample S on the sample holding device 12, the computer processing unit CP2 will carry out the following procedure:

1) the CP2 initially switches the speed of the carrier member 10 to the above “cutting speed” and switches the alcohol spray pump 35, vacuum pump 37 and milling tool motor 17 to “on”;

2) after the CP2 positions the carrier member 10 to locate the sample S at the “cutting start” position PC (FIG. 2) where the sample is ready to be sectioned by tool 16, the CP2 switches the speed of the carrier member 10 to “stop”;

3) the CP2 program waits 20 seconds to allow for thermal equilibrium to be achieved (e.g. equilibrate cooling effect of alcohol spray on the sample and sample holding device),

4) the CP2 sets the speed of carrier member 10 to the “cutting speed”,

5) the CP2 moves the carrier member 10 to move the sample S through the cutting area to cut a section of the sample with the milling tool 16,

6) when the sample reaches the “end cutting” position PE (FIG. 3), the CP2 switches the alcohol spray pump 35 to “off” and the speed of the carrier member 10 is set to the “fast speed” to move the sample toward the “photo” position. The sample “end cutting” position is determined by the CP2 reading the voltmeter read-out;

6A) the sample can be stopped and manually etched, if necessary, between steps 6) and 7),

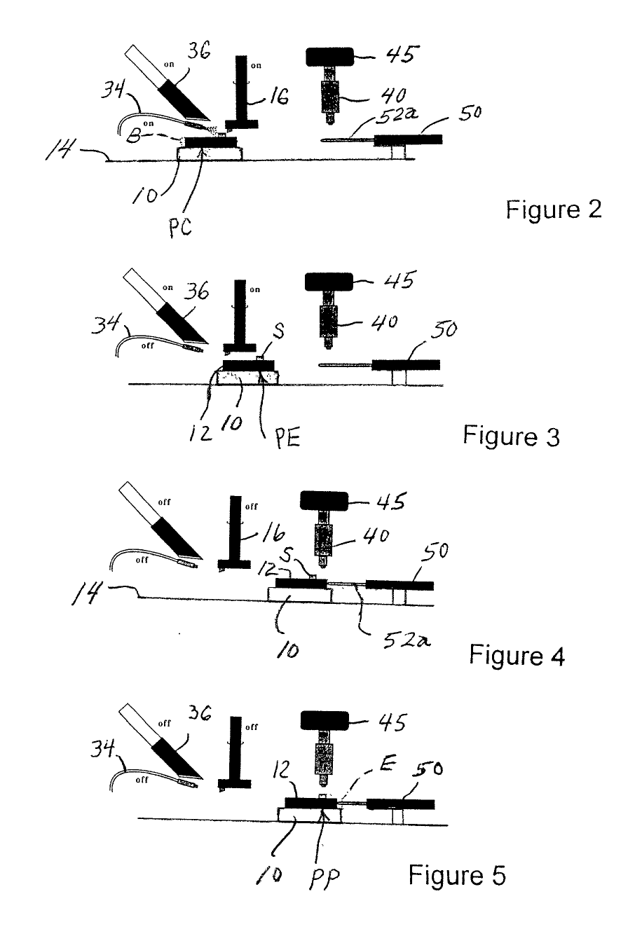

7) when the sample is within 5 millimeters of the “photo” position (FIG. 4), the speed of the carrier member is set to “slow speed” and the vacuum pump 37 and milling tool motor 17 are set to “off”. The sample position is determined through the voltmeter readout;

8) when the sample reaches the “photo” position PP (FIG. 5), the CP2 sets the speed of carrier member 10 to “stop”; and the user of the machine is prompted by the CP2 to take a picture of the sample section and then click NEXT. The sample position when the picture is taken is determined by the LVDT readout. The digital image is stored in memory of the computer processing unit CP;

9) a reference number assigned to the particular sample section photographed and the exact LVDT readout for that sample section photograph are saved (stored) to a file “photo-positions.txt” of CPU program memory of CP2.

10) when the user clicks NEXT, the speed of the carrier member 10 is set to “cutting speed”, and the pumps 35, 37 and milling tool motor 17 are switched “on”;

11) the sample holding device 12 is moved by the carrier member under control of the machine controller MC to an end position E (dotted lines-Figure 5) and then back to a beginning position B (dotted lines-Figure 2) per the standard micromiller set-up procedure and then to the “cutting start” position (solid lines FIG. 2); and the tool head slide 18 and the microscope 40 are lowered by a preselected increment of micrometers (e.g. 5 micrometers) by actuation of tool head slide stepper motor 22 as controlled by machine controller MC. The “cutting start ” position and “photo” position are located within a few millimeters of the end E and beginning B, respectively, established by the micromiller set-up procedure.

The CP2 program then continues to repeat steps 2) through 10) to mill a next horizontal section of the sample S at position Pi and then photograph it at position P2 as described above. In this way, a series of digital photographic images of the serially sectioned sample S can be stored in program memory of CP and the sensed positions of the sample holding device 12 in the Y direction at the “photo” position can be stored in program memory of CP2.

In step 8) of the procedure, CP2 program can include an automatic prompt for a picture of the sample section to be taken, rather than have the machine user be prompted to manually take the picture. The camera 45 could include camera actuator interfaced via a switch (not shown) on the switchboard 65 so as to take a picture under control of the CP. In this way, the sample can be serially sectioned and photographed in automatic manner without user intervention.

In conducting the procedure describe above, the milling tool 16 can be moved in increments of, for example only, 2 to 20 microns at each successive step 11) to mill successive sections of the sample S. The above stepper motor 22 can be used to lower tool head slide 18 to this end. In addition, in conducting the procedure described above, the micromilling machine should be operated for 45 minutes to establish a thermal equilibrium condition before starting the serial sectioning and photographing procedure. Alternately or in addition, thermal equilibrium can be established by serial sectioning and photographing of the sample S with the data generated for the first few sections discarded or ignored.

The above serial sectioning and photographing procedure is advantageous in that the alignment of sample sections, which allows the digital images to be aligned automatically by the computer processing unit CP3 as described below, is based on externally determined positions of the sample holding device 12 and thus sample S during each section cut at location P1 and photographing at location P2 and does not rely on features in the images themselves which heretofore had to be matched between different sections. Moreover, mounting of the microscope 40 on the tool head slide 18 avoids all the steps associated with sample mounting/demounting on the sample holding device heretofore required and reduces alignment errors associated with sample mounting/demounting on the sample holding device. The procedure of serial sectioning and photographing pursuant to the invention thus increases precision and speed of making serial sample sections and corresponding serial photographs thereof. Speed of making serial sections and photographing them is increased by at least a factor of 10 over prior serial sectioning and photographing methods.

Importantly, pursuant to the invention, the 3D sectional image of the sample S is reconstructed and visualized by computer processing unit CP3 using the series of stored digital photographic images and the corresponding series of sensed “photo” positions of the sample holding device 12 in the Y direction where the images were taken wherein the sensed “photo” positions can exhibit scatter (be displaced relative to one another) in the Y direction by up to 50 microns as a result of sample positioning control limits inherent in control of motor 32. A 3D reconstruction and visualization of micron scale metallic microstructural or biological features can be made with vertical separation distance of the sample cross-sections spaced as little as 2 microns apart depending upon the selected incremental advance of the tool head slide 18 toward the sample.

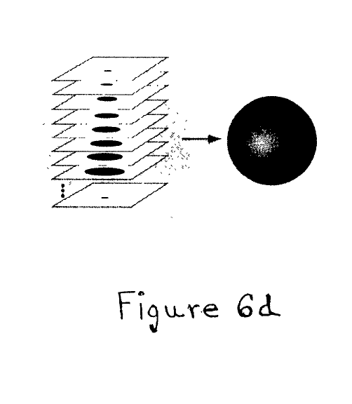

The method by which the series of images of the sample sections are computer aligned is illustrated in FIGS. 6a, 6b, 6c and 6d where the full images of the series of the sample sections taken at the sensed sample holding device positions are shown vertically stacked in FIG. 6a. From each image, one can obtain a sub-image by erasing or cutting a number of lines in the Y direction according to the sensed “photo” position information (in the Y direction). As an example, we assume a resolution of 1 micron per pixel of the image, an image size of 1000 ×1000 pixel, and that our sensed “photo” positions do not scatter in the Y direction by more than 50 microns. Then, for the first sample section image, we take a sub-image of 1000 ×900 pixel that we obtain from the original full size image by erasing 50 lines (50 microns) on the left side of the image in FIG. 6b in the Y direction and 50 lines (50 microns) on the right side of the image in the Y direction. Assuming the next sample section image has a sensed “photo” position displacement in the Y direction relative to the sensed “photo” position of (−11) microns in the Y direction of the preceding image, we reduce the corresponding 1000 ×1000 pixel image of the second sample section to a 1000 ×900 pixel image by erasing 39 lines (39 microns) on the left side of the image in FIG. 6b in the Y direction and 61 lines (61 microns) on the right side of the image in the Y direction to create a sub-image. The other sample section images are treated (lines erased) similarly as necessary to create a stack of 1000 ×900 pixel sub-images, FIG. 6c, aligned within one pixel of one another regardless of the pixel resolution and assuming the LVDT measures the sensed sample holding device position with sufficient accuracy in the Y direction. Thus, the 3D image of the sample is a combination of all of the 2D sub-images, FIG. 6c and 6d, aligned as described above. 3D image reconstruction in the manner described above can be conducted using computer processing unit CP3 running conventional image analysis software such as IDL (Interactive Data Language) available from Research Systems, Inc., 4990 Pearl East Circle, Boulder, Colo. 80301.

While the invention has been described hereabove in terms of specific embodiments thereof, it is not intended to be limited thereto and modifications and changes can made therein without departing from the spirit and scope of the invention as set forth in following claims.

WE Claim

1. Apparatus for sectioning and examining a sample of a material, comprising :
a) a tool positionable to remove a predetermined thickness of material from the sample to provide a sample cross-section,
b) a microscope spaced from the tool,
c) a sample holding device on which a sample of the material is disposed, said sample device being movable in a direction to dispose said sample at a first location where the tool removes the predetermined thickness of material from the sample to provide said sample cross-section and to a second location where the sample holding device is positioned relative to the microscope,
d) a position sensing device for sensing the position of the sample holding device at the second location, and
e) means for storing the sensed position of the sample holding device at the second location.

2. The apparatus of claim 1 wherein the tool and the microscope are disposed to move synchronously relative to the sample.

3. The apparatus of claim 1 including a digital camera operatively associated with the microscope at the second location to provide a digital image of the sample cross-section.

4. The apparatus of claim 3 wherein said storing means comprises a first computer processing unit for storing the digital image of the sample cross-section and a second computer processing unit for storing the sensed position of the sample holding device at the second location.

5. The apparatus of claim 1 further including a second position sensing device for sensing the position of a carrier member by which said sample holding device is moved in the second direction and wherein a carrier actuator motor is controlled in response to the sensed position of the carrier member.

6. The apparatus of claim 5 wherein a computer processing means controls the speed of movement of the carrier member.

7. The apparatus of claim 6 including a fluid spray device controlled by said computer processing means to spray a fluid on the sample when the sample holder is positioned at the first location.

8. The apparatus of claim 6 including a suction device controlled by said computer processing means to suction debris from the sample when the sample holding device is positioned beneath the tool.

9. The apparatus of claim 1 wherein the tool is a milling tool.

10. The apparatus of claim 1 wherein the position sensing device comprises a position transducer for engagement by the sample holding device.

11. The apparatus of claim 1 wherein a computer processing means controls the milling tool.

12. Apparatus for generating a three dimensional image of a sample of a material, comprising :
a) a tool positionable in increments to remove a predetermined incremental thickness of material from the sample to provide a sample cross section,
b) a microscope spaced from the tool,
c) a sample holding device on which a sample of the material is disposed, said sample holding device being movable in a direction to dispose said sample at a first location where the tool removes the incremental thickness of material from the sample to provide said sample cross-section and to a second location where the sample holding device is positioned relative to the microscope, said sample holding device being repeatedly so moved to generate a series of sample cross-sections,
d) a camera for generating a respective digital image of each respective sample cross-section at the second location,
e) a position sensing device for sensing the position of the sample holding device each time it is at the second location,
f) means for storing each respective digital image and the corresponding respective sensed position of the sample holding device at the second location for each respective one of the sample cross-sections, thereby storing a series of respective digital images and corresponding sensed positions, and reconstructing a three dimensional image of the sample from the series of the digital images and the series of corresponding sensed positions.

13. The apparatus of claim 12 including a computer processing unit operable to generate a respective sub-image from the respective digital image of each respective one of the sample cross-sections in response to the sensed position and aligning each respective sub-image with the next sub-image to generate the three dimensional image.

14. A method for generating a three dimensional image of a sample of a material, comprising :
a) disposing the sample of the material on a sample holding device,
b) moving the sample holding device to a first location where a tool removes a predetermined thickness of material from the sample to provide a sample cross-section,
c) moving the sample holding device to a second location where a digital image of the sample cross-section is generated and stored,
d) sensing the position of the sample holding device at the second location where the digital image is generated and storing the sensed position,
e) repeating steps a) through d) to provide a series of digital images and a corresponding series of sensed positions, and
f) constructing a three dimensional image of the sample using the series of digital images and the corresponding series of sensed positions.

15. The method of claim 14 including generating respective sub-images from the respective digital images in response to the respective sensed position of the sample holding device by aligning each respective sub-image with the next sub-image.

16. The method of claim 14 wherein the tool and a microscope with digital camera are moved synchronously toward the sample.

17. The method of claim 14 further including sensing a position of a carrier member on which the sample holding device is disposed and moved in the second direction between the first location and second location.

18. The method of claim 17 including controlling an actuator motor connected to the carrier member in response to the sensed position of the carrier member.

19. The method of claim 14 wherein the tool comprises a milling tool to remove the material from the sample.

20. The method of claim 14 wherein the tool moves in a first direction perpendicular to a second direction of motion of the sample holding device.

21. The method of claim 14 wherein a sample comprising a metallic material is disposed on the sample holding device.

22. The method of claim 14 wherein a sample comprising an organic material is disposed on the sample holding device.
